(19) United States
(12) Patent Application Publication
(10) Pub. No.: US 2019/0373859 A1
(43) Pub. Date: Dec. 12, 2019

(54) WHEEL TRACK TOY

(71) Applicant: Elizabeth Bentz, Denver, CO (US)

(72) Inventor: Elizabeth Bentz, Denver, CO (US)

(21) Appl. No.: 16/003,892

(22) Filed: Jun. 8, 2018

(51) Int. Cl. A01K 15/02

(52) U.S. Cl. CPC A01K 15/025

(57) ABSTRACT

The invention is a novel pet toy wherein an upright wheel toy that has two halves which snap together after a pet owner has placed a ball or balls in a half and snaps the two together leaving a center track for the balls to rotates within as the wheel toy is propelled along a surface. The surface sections have a gripping material to provide traction on smooth surfaces.

### FIELD

The present invention relates generally to stimulating, encouraging and motivating games and methods of playing regarding pets, e.g. dogs and cats. More particularly, the invention relates to motivational games, toys and methods for assessing the pet training skills in the form of games or puzzles that incite pet interaction and memory skills.

### PRIOR ART

There are many types of cat toys on the market, and with various functions and features. The inventive wheel track toy is designed to entertain pets with or without the pet owner's involvement.

### BRIEF DESCRIPTION OF THE INVENTION

The novel design of the inventive toy allows the wheel to travel across a surface, and a ball or balls inserted into the smooth inner tracks will spin around in the toy frame creating interest by the pet. Typically, a cat with this toy.

The object of the present invention is to motivate and maintain interest of a pet. The plastic molded wheel toy is comprised of two circular layers which snap together leaving space for an inner track as well as creating track edges that will roll along a surface. The outer tracks that contact a surface each have a band of material that is textured plastic or rubber to create traction while still allowing the track to roll across a surface. The toy is balanced so as not to tend to lean toward one side or the other in a side to side motion. The track will roll much as a wheel does on a given surface.

The wheel toy has a circular opening in the center, and a groove within an internal circumference created when two halves of the track are snap fit together. This groove creates an area for balls to roll around in when the track toy has been pushed across a surface. As the wheel track rolls, the balls will rotate around inside the groove without coming out of the toy. The space between the two halves also have a small overlap edge, which, when combined with the other half, creates a lip that will hold balls in the toy's track, but still allow interaction by the pet with the balls.

### BACKGROUND OF THE INVENTION

The invention most closely corresponds with USPTO Class 119/707 wherein Class 119 relates to animal husbandry and sub-class 707 includes toys, lures, fetch and related devices.

In its simplest form, the invention relates to a novel toy for pets that is shaped like a wheel and contains a grooved section where balls can be inserted and travel around the wheel track toy as it is moved by a pet along a surface.

### THE INVENTION

### Summary, Objects and Advantages

It well known that pets do experience a sense of boredom, and if not addressed, may manifest in negative behavior such as chewing furniture or going to the bathroom in undesirable locations in the pet owner's home. The inventive toy is designed to capture and retain a pet's interest whether the pet owner is away or home. The pet owner can manipulate the toy in some way to actively play with the pet as well. The toy is not designed to “replace” human interaction, but rather to help keep a pet entertained even if the owner is not also interacting with the toy and pet.

The inventive toy includes two plastic molded circular halves which snap together. A pet owner can place a ball or multiple balls within the center groove prior to snapping the halves together. The balls are then in a track and able to rotate around commensurate with the wheel toy being rolled along a surface.

### BRIEF DESCRIPTION OF THE DRAWINGS

The invention is described in further detail by reference to eight (8) drawings sufficient in detail to describe the invention in which:

FIG. 1 is an illustration of the wheel track toy with the halves attached to one another;

FIG. 2 is an exploded view of the plastic halves and the gripping material which is affixed to the outer two halves;

FIG. 3 is a top and side view of the track toy;

FIG. 4 is a perspective view of the track toy;

FIG. 5 is a view of the ball and grip surface; and

FIG. 6 is a head-on perspective showing ball in track.

### DETAILED DESCRIPTION, INCLUDING BEST MODES OF CARRYING OUT THE INVENTION

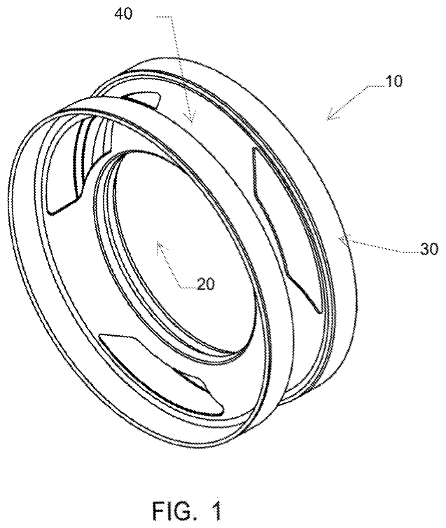

FIG. 1 shows the molded plastic wheel toy 10 as fully snap-fit together. The center 20 is open as in a donut shape. Each half of the wheel has a gripping material 30 affixed thereto so as to keep traction on very smooth surfaces. A groove or inner track 40 is created when the two halves are snapped together.

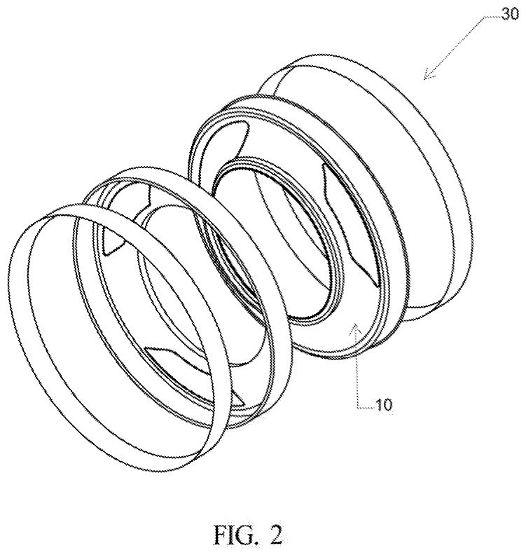

FIG. 2 is an exploded view indicating the four pieces of the toy. The key features shown here are the gripping material 30 which encircles and is affixed to the halves of the track which contact a surface 10. With the gripping material affixed the toy attains better traction when rolled on a smooth surface.

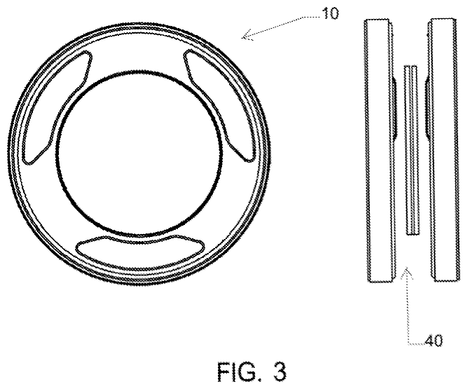

FIG. 3 is a top view of the toy 10 as appears from above when the toy is laying on its sides versus being in an upright “position as a wheel requires to be in to roll. A head-on view illustrates the groove or track 40 that is created when the two halves of the toy are snapped together.

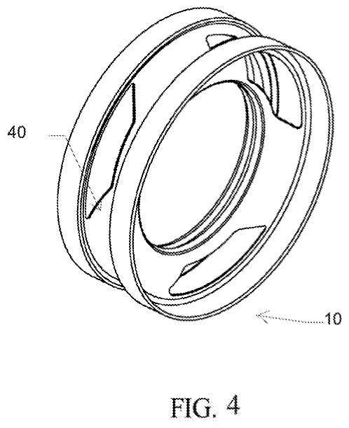

FIG. 4 is a simple perspective of the wheel track toy 10 wherein again the track 40 created when the pieces are snapped together is also shown.

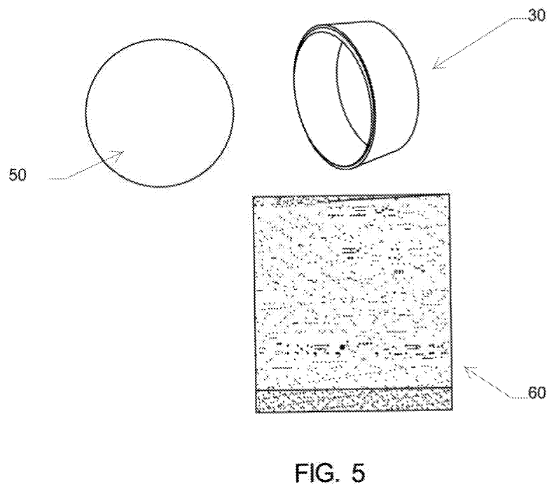

FIG. 5 shows the gripping material 30 as a circular strip which is affixed to the halves of the toy that contact a surface. A simple ball 50 is shown, however multiple embodiments can be created by using a different ball type, such as a ball with a bell inside, a ball with catnip inside, etc. The gripping material 30 is also shown in a magnified view 60.

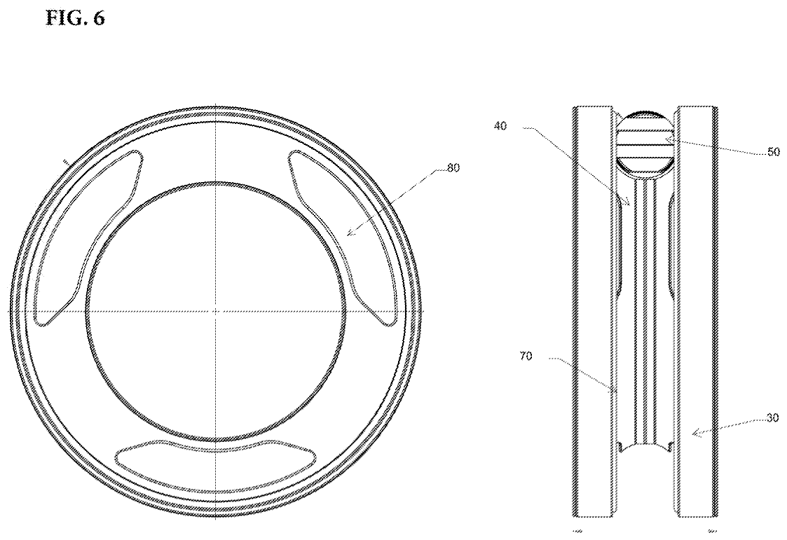

FIG. 6 is a head-on view of the track as contains a ball 50 that will slide around the track 40 when the toy is rolled along a surface. The ball cannot be removed except as when a user detaches the two halves and removes or adds a ball and snaps the toy together. In this way a sort of lip 70 is created which prevents the ball from easily popping out of the track. In this Figure it is also shown that the toy contains cutout sections 80 in addition to the center cutout disclosed previously. These cutouts are primarily to serve aerodynamics and for a user or pet to have sections to grasp easily.

1) A pet toy comprising:
a) Two identical halves of a molded plastic circular shaped wheel wherein each half is removably snap fit together and wherein the inside edges form a small hangover or lip section which do not touch one another, and create an indented center area track when the halves are snapped together;
b) A channel or track section to receive balls as created when the two halves are snapped together wherein the ball is not removeable;
c) A textured plastic circular sleeve which is affixed to the outer sides of the two sections of the wheel that contact a surface;
d) A circular cutout in the center of each wheel section which will mirror one another when the halves are snapped together;
e) Three elongated rectangular cutouts on each half of the wheel which mirror one another when the halves are snapped together.

2) A pet toy as in claim 1 wherein the wheel shaped halves are detachable from one another so that a user can insert one or more balls into one half and snap the other onto it to create a track.

3) A pet toy as in claim 1 wherein a center track formed creates a travel track for balls when inserted by a user, and wherein the lip that is formed by the center potions of the two halves holds the ball in the track while allowing them to rotate around the circular portion of the toy.

4) A pet toy as in claim 1 wherein two textured circular plastic bands are affixed to each of the toy halves that contact a surface to create traction for the wheel toy

5) A pet toy as in claim 1 wherein the center of the wheel track toy has a large circular cutout to aid the toy in aerodynamics as well as create an easy way for users to grasp the toy.

6) A pet toy as in claim 1 wherein three elongated cutouts are located equidistant from one another on each of the toy halves and mirror one another when the halves are snapped together.
